(19) United States
(12) Patent Application Publication
(10) Pub. No.: US 2012/0307387 A1
(43) Pub. Date: Dec. 6, 2012

(54) MIRROR HOUSING CLAMP ARRANGEMENT

(76) Inventors: Werner Lang, Ergersheim (DE); Albrecht Popp, Weihenzell (DE); Stefan Centmayer, Ergersheim (DE); Ralf Wattenbach, Burgbernheim (DE)

(21) Appl. No.: 13/311,992

(22) Filed: Dec. 6, 2011

(30) Foreign Application Priority Data
Dec. 8, 2010 (DE) 10 2010 062 642.2

(51) Int. Cl. B60R 1/02

(52) U.S. Cl. 359/871

(57) ABSTRACT

A mirror head releasably fastened to a support structure, whereby the mirror head has at least one recess complementary to the support structure, into which the support structure or a partial segment of support structure is inserted and which is secured by means of a fastening device. Matching surface segments are formed in at least one recess and the corresponding surface segment of the support structure, and the fastening device is formed as an elastic component that pre-stresses ratchet surfaces in the recess and on support structure into interlocking engagement. The support structure ratchet surface may be formed on a separate locking component with a surface that at least partially matches the surface contour of the support structure, where the position of the locking component relative to the support structure can be fixed in its circumferential and axial direction.

### BACKGROUND OF THE INVENTION

1) Field of the Invention

The present invention relates to vehicle mirror assemblies, and more particularly, to a mirror head mounting arrangement for an exterior rearview mirror.

2) Description of Related Art

A typical exterior mirror arrangement for larger trucks and commercial vehicles includes a mirror head, which contains/comprises at least one mirror surface, which is secured to a support structure. The support structure in turn is fastened to the vehicle body. To fasten the mirror head releasably to the support structure, the mirror head has at least one formed recess that is complementary to the support structure, in which the support structure is inserted and which is secured by means of a fastening device.

In practice, requirements are set to mirror arrangements of this type that are contrary to each other: on the one hand, the fastening device between the mirror head and support structure should be fatigue free and vibration resistant; on the other hand, the fastening device should allow an adjustability of the mirror head vis-à-vis the support structure. Furthermore, the fastening device between the mirror head and the support structure should be reversible to the extent that a push or a stroke against the mirror head of the latter will cause an evasive movement to be carried out, as, for example, when the mirror head hits an obstacle.

Accordingly, it is an object of the present invention to provide a mirror housing clamp able to securely fasten the mirror head to the support structure in a fatigue free and vibration resistant manner.

It is a further object of the present invention to provide a mirror housing clamp able to adjust the position of the mirror head relative to the support structure.

### SUMMARY OF THE INVENTION

The above objectives are accomplished according to the present invention by providing a mirror housing clamp arrangement wherein ratchet surfaces are formed on the surface of engaging components in at least one mirror head recess and in a correlated complementary recess of the support structure, whereby a fastening device is provided in the form of an elastic clip component, which pre-stresses both ratchet surfaces in the locking position.

By means of the formation of the ratchet surfaces in the mirror head-side recess and in the surface of the support structure, it is possible to achieve sufficiently high holding forces between the mirror head and the support structure, whereby the holding forces are also vibration resistant and fatigue free. By means of the elastic bracket component, which prestresses both ratchet surfaces in the locking position, the connection between the mirror head and support structures imposes a certain elastic flexibility, which, on the one hand, serves to dampen vibrations, thus increasing the functionality of the mirror arrangement, and on the other hand, permits an adjustment of the mirror head vis-à-vis the support structure in steps or increments. Furthermore, with a stroke or push on this mirror head, an evasive movement can be carried out when the elastic holding forces of the elastic component are overcome by that stroke or push and the respective ratchet surfaces or ratchet surface segments are disengaged.

In one embodiment, the support structure-side ratchet surface on the support structure is separately formed, at least partially on a locking component, which is secured in position in its circumferential and axial direction along the support structure. As a result, it is possible in an especially advantageous manner to avoid a surface modification (deformation, etc.) of the support structure. The support-side ratchet surface is formed on the separate locking component, which is at least partially matched to the surface contour of the support structure, so that the locking component can be attached to the support structure or positioned or slid onto it, in order to then fix the support-side ratchet surface in the desired position. By means of fixing the position of the locking component facing the support structure in both its circumferential and axial direction, the locking component is then in the position to form the ratchet surfaces on the structure surface-side to match one of the ratchet surfaces, which would be formed directly on the surface or on a partial section of the support structure. In contrast to the latter procedure, however, costly processing steps of the support structure can be avoided.

The support structure is preferably a rod-shaped or tube-shaped component and the locking component surrounds the outer circumference of this rod-shaped or tube-shaped component. If the ring shape of the locking component completely surrounds the support structure for stability reasons according to another preferred embodiment, the ring-shaped locking component can simply be slid onto the circumference of the rod-shaped or tube-shaped component.

The fixing of the ring-shaped locking component in the circumferential direction of the support structure can hereby be carried out then either by means of a positive-locking fit between the locking component and the support structure, e.g., if the support structure has a cross-section deviating from the circle shape. For fixing the position in the axial direction, then at least one pin extending radially through the locking component is to be provided, which can be brought into engagement with the support structure. If the support structure has a circular cross-section, this pin will also secure the locking component in position in the circumferential direction of the support structure.

Particularly preferred here is the self-locking pin and in particular formed in the manner of an expanding mandrel. The pin and expanding mandrel design force through a borehole in the ring-shaped locking component and come to rest with its shaft in the support structure. If the component from which the support structure is formed is tube-shaped/hollow, the shaft of the expanding mandrel according to the preferred embodiment of the pin as the expanding mandrel can automatically expand inside the tube-formed component of the support structure, so that the locking component is locked in the circumferential direction as well as in the axial direction to the support structure. In addition to the fixing of the locking component position for the formation of the later support structure-side ratchet surface, the attachment of the locking component to the support structure by means of the self-locking pin and expanding mandrel facilitates the mounting of the entire mirror arrangement, since already in the course of the mounting, the locking component is locked in its final position to the rod-shaped or tube-shaped component of the support structure.

Furthermore, the locking component seen in the axial direction of the support structure is preferably in a positive-locking engagement with the mirror head. A locked positioning of the mirror head relative to the support structure is hereby guaranteed.

The elastic component is preferably formed in the manner of a bracket or clip, which presses on a surface segment opposite from the ratchet surfaces. Both ratchet surfaces are hereby engaged with each other by means of the elastic force of the clip, in order to apply the necessary holding forces. Simultaneously, the elasticity of the clip permits a positioning of the mirror head facing the support structure in the steps or increments corresponding to the ratchet surfaces and/or evasive movements of the mirror head relative to the support structure.

The clip here is preferably a spring clip, which is positioned on the locking component of the support structure and fastened to the mirror head by a corresponding fastening member.

### BRIEF DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 shows a side view of a mirror arrangement according to the invention with an opened mirror head and an exposed support structure;

FIG. 2 shows a top view of the top of the mirror arrangement of FIG. 1;

FIG. 3 shows an exploded perspective depiction of the mirror arrangement of FIG. 1;

FIG. 4 shows an exploded end view of the mirror arrangement of FIG. 3 seen from the direction of arrow IV in FIG. 3;

FIG. 5 shows a top view corresponding to FIG. 2 without the support structure;

FIG. 6 shows an enlarged detailed depiction of area VI in FIG. 5; and,

FIG. 7 shows a perspective view of the ring-shaped locking component according to the present invention.

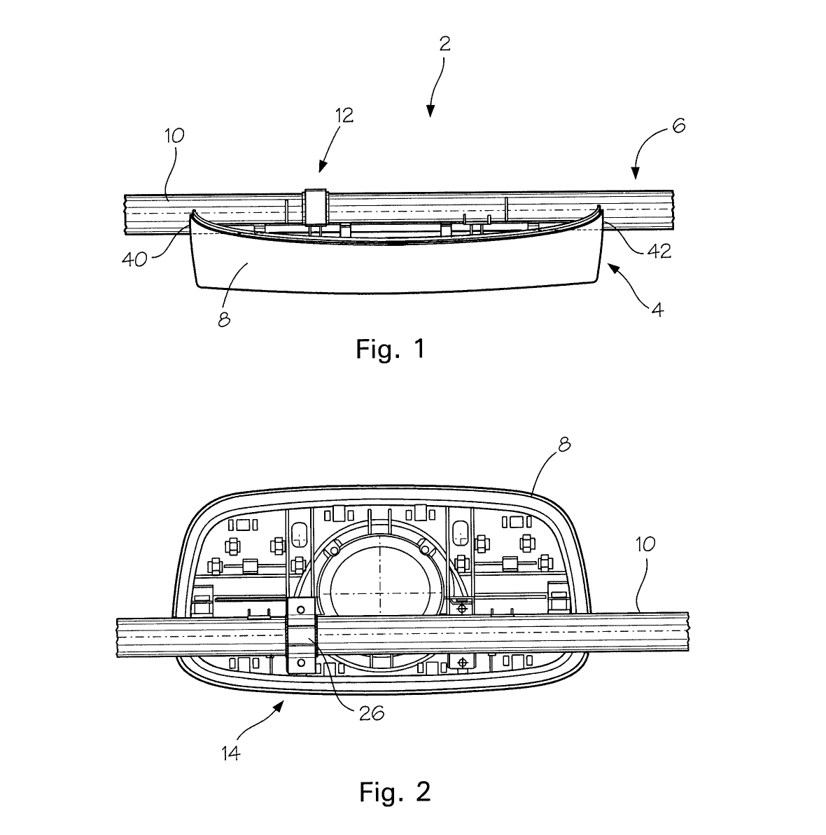

In the following description, which refers to FIG. 1 to 7, the same reference signs identify similar or functionally identical components in the individual figures. Furthermore, it should be noted that the depictions in the individual figures of the drawing are purely illustrative and should not be interpreted as limitations to the technical concept.

It will be understood by those skilled in the art that one or more aspects of this invention can meet certain objectives, while one or more other aspects can meet certain other objectives. Each objective may not apply equally, in all its respects, to every aspect of this invention. As such, the preceding objects can be viewed in the alternative with respect to any one aspect of this invention. These and other objects and features of the invention will become more fully apparent when the following detailed description is read in conjunction with the accompanying figures and examples. However, it is to be understood that both the foregoing summary of the invention and the following detailed description are of a preferred embodiment and not restrictive of the invention or other alternate embodiments of the invention. In particular, while the invention is described herein with reference to a number of specific embodiments, it will be appreciated that the description is illustrative of the invention and is not constructed as limiting of the invention. Various modifications and applications may occur to those who are skilled in the art, without departing from the spirit and the scope of the invention, as described by the appended claims.

### DETAILED DESCRIPTION OF A PREFERRED EMBODIMENT

With reference to the drawings, the invention will now be described in more detail.

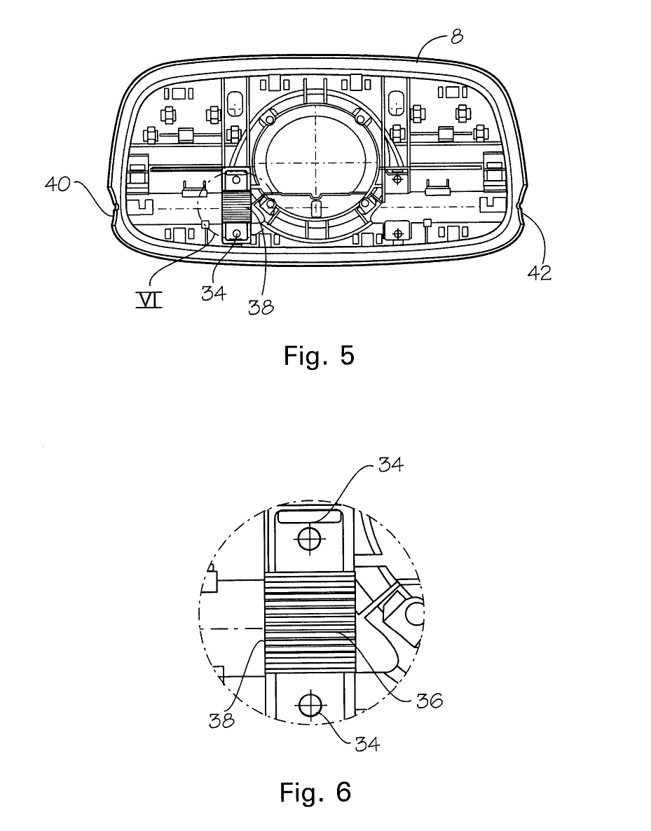

One mirror arrangement described in the drawing in its entirety as 2 basically comprises a mirror head, designated generally as 4, and a support structure, designated generally as 6. Mirror head 4 consists in a known manner of two dish-shaped bodies, whereby in the drawing (e.g., FIG. 1) only one of the two dishes 8 is depicted. Another dish would, for example, in the depiction of FIG. 1, be positioned top down on dish 8, whereby both dishes grasp between them the support structure 6 in FIG. 6.

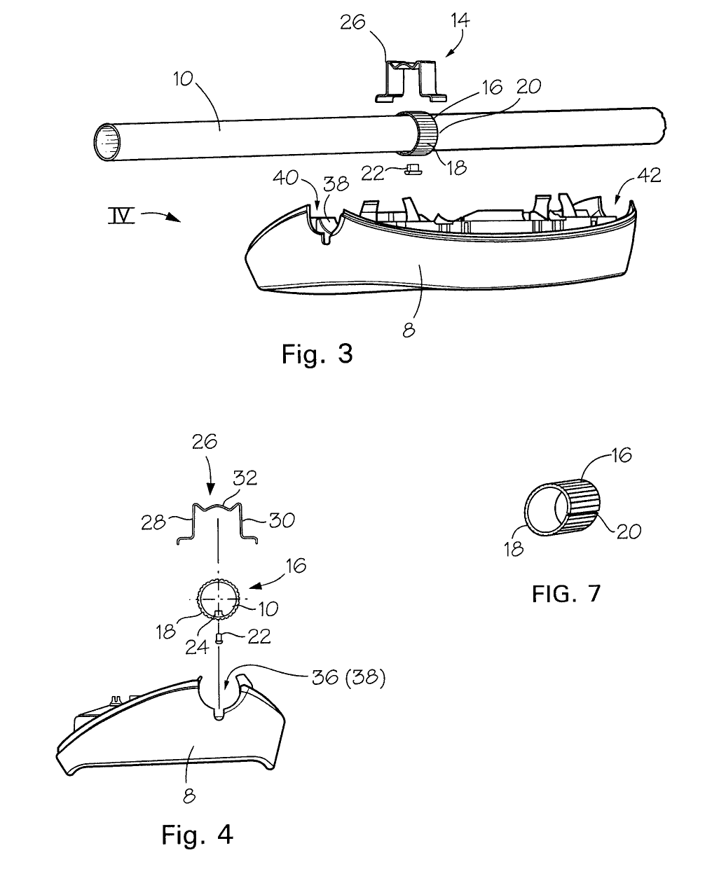

In the illustrated arrangement, support structure 6 includes a rod or tube-formed component 10. Rod component 10 is, for example, a metal tube with a circular cross-section (e.g., FIGS. 3 and 4) which is used for the positioning of mirror head 4 on a vehicle, whereby in rod component 10, fastening means (such as a mounting bracket) for mounting it on the vehicle body are provided, but are not more fully described as such arrangements are well known in the art.

Between mirror head 4 and the support structure 6, thus in the embodiment between dish 8 and rod component 10, there is at least one holding device, designated generally as 12, which attaches dish 8 to rod component 10. The holding device 12 comprises at least one formed recess 38, which is complementary to the shape of support structure 6, i.e. to the outer circumference and/or cross-section of rod component 10, into which component 10 is inserted and attached by means of a fastening device 14. In at least one recess 38 and on a complementary arranged surface segment of support structure 6 (of rod component 10), ratchet surfaces 16 and 36 complementary to each other are formed, which are embodied such that dish 8 can be essentially secured in rotational position relative to rod component 10. The term “essentially” should be understood here to mean that the use of fastening device 14, as described below, will secure dish 8 in the circumferential direction of rod component 10 vibration-proof, but will permit movement in steps or increments when a certain limit value holding force of the fastening device 14 is exceeded.

Ratchet surface 36 on mirror head-sided recess 38 comprises, as an example, a plurality of serrations or grooves running parallel to each other, basically equidistantly arranged, which extend axially relative to rod component 10. This mirror head-sided ratchet surface 36 can be engaged with support structure-side ratchet surface 16, which is formed on a separate locking component 18. With further reference to FIG. 7, the locking component 18 is at least partially matched to the surface contour of the support structure 6 or rod component 10 and can basically be ring-shaped according to an embodiment and can grasp the outer circumference of rod component 10, as shown in FIG. 3. The locking component 18 may be a closed ring, so that the locking component 18 is mounted on rod component 10 by sliding it on a free end of rod component 10. In another embodiment, the locking component can be opened or widened through a slot 20, so that locking component 18 can be clipped onto the outer circumference of rod component 10 and then closed around rod component 10.

For locking the position of locking component 18 relative to rod component 10, at least one pin 22 is provided that extends through the material of the locking component 18 into an axially aligned slot or borehole 24 and inserts it into rod component 10. Preferably, pin 22 is hereby formed in the manner of an expanding mandrel, so that with a tube-formed configuration of rod component 10, the shaft of pin 22 in the inserted position is automatically expanded inside rod component 10, thus preventing pin 22 from falling out.

By means of at least one pin 22, locking component 18 is locked into position to the outer circumference of rod component 10 both in its circumferential direction and in its axial direction. The locking position in the circumferential direction can also be carried out or aided by a form-locking engagement between locking component 18 and rod component 10 if the latter has a cross-section deviating from the circle shape, thus, for example, it is formed elliptically. Pin 22 then basically assures the locking of position of locking component 18 in the axial direction of rod component 10.

Locking component 18 bears a locking profile on at least a partial section of its outer circumference, which forms ratchet surface 16, which is complementary to ratchet surface 36 of mirror head 4 in the area of recess 38. By means of the engagement of both ratchet surfaces 16 and 36, the locking of the position of mirror head 4 takes place in an essentially non-rotatable manner relative to rod component 10.

The engagement of both ratchet surfaces 16 and 36 with each other by means of a given engaging force is carried out by the fastening device 14, which, according to FIGS. 3 and 4 can be a bracket or clip 26, which is spring-formed and which essentially has a U-shaped cross-section with two shanks 28 and 30 interconnected by a flexible engaging surface 32. The free ends of both shanks 28 and 30 are laterally bent and form contact surfaces and/or fastening surfaces, with which clip 26 can be attached to dish 8, for example, by means of a screw connection, expanding mandrel, etc., which can be inserted in slots 34 that are formed on the side of dish 8 and which are best shown in the blown-up drawing of FIG. 6.

With the mounted clip 26, the latter presses with flexible engaging surface 32 on one of the surface segments of support structure 6 and rod component 10 opposite to the ratchet surfaces 16 and 36, so that both ratchet surfaces are engaged with each other with an elastic force. This elastic engagement of both ratchet surfaces can be overcome by exceeding the limit force of the spring force of the clip 26, so that dish 8 and thus the entire mirror head 4 can be adjusted in steps relative to rod component 10 and thus the support structure 6. Similarly, under the influence of a greater, outside force (push, stroke, etc.,) mirror head 4 carries out corresponding evasive movements.

In the area of recess 38, means of intervention are provided by dish 8, which permit the locking component 18 mounted on rod component 10 in the axial direction of rod component 10 to engage in a positive-locking engagement or in a positive-lock system with dish 8 and thus mirror head 4.

Since the ring-shaped locking component 18 extends beyond the circumference of rod-shaped or tube-shaped component 10 by at least its material thickness, these means of intervention may be formed by corresponding webs, for example, that limit recess 38 on one or both sides in an axial direction, so that locking component 18 is locked either on one side against such a web or is locked on both sides between two such webs, so that dish 8 is secured on one side or both sides against an axial displacement relative to rod component 10 and thus to support structure 6.

To mount the mirror arrangement according to the invention, locking component 18 is slid or clipped to rod component 10 and locked in its mounting position by one or several pins 22. By using several locking components 18 corresponding to more recesses of dish 8, a corresponding number of additional components 18 are slid or clipped to rod component 10 and locked by one or more pins 22. Rod component 10 is thus inserted into dish 8 from above as in FIG. 1, whereby the recesses 40 and 42 in the dish body least partially surround the outer circumference of rod component 10. The support contour ratchet surface 16 on locking component 18 engages with mirror head-sided ratchet surface 36 in recess 38. Clip 26 is positioned from above on this arrangement and locks with its shanks 28 and 30 secured to slots 34 on dish 8, such that engaging surface 32 presses down on rod component 10, which presses the locking engagement between ratchet surfaces 16 and 36. Dish 8 of mirror head 4 is essentially non-rotatably locked relative to rod component 10 of support structure 6 in the protected manner by ratchet engagement. An axial locking of mirror head 4 relative to support structure 6 takes places by means of the positive form locking system or by the engagement of the locking component or locking components 18 in the area of the recess or recesses 38 by the webs therein or by functionally equivalent positive form-locking means.

In connection therewith, the second dish not depicted in the drawing is positioned on the arrangement approximately according to FIG. 1, so that both dishes of mirror head 4 lock rod component 10 of support structure 6 between them.

In summary in this respect, a mirror housing clamp arrangement has been described, in particular for vehicle rearview mirrors, with at least one mirror surface bearing a mirror head, which is releasably fastened to a support structure by an elastic fastening device, whereby the mirror head has at least one recess complementary to the support structure, into which the support structure or a partial segment thereof is inserted and secured together by the elastic fastening device. Ratchet surfaces are formed in at least one recess and on a correlated complementary surface segment of the support structure and the fastening device is formed as an elastic clip component that pre-stresses both ratchets in the locked position. It is particularly preferred that the support structure-sided ratchet surface can hereby be formed on a locking component that is separate from the support structure with at least a partially matching surface contour, where the position of the locking component is fixed in its circumferential and axial direction relative to the support structure.

While a preferred embodiment of the invention has been described using specific terms, such description is for illustrative purposes only, and it is to be understood that changes and variations may be made without departing from the spirit or scope of the following claims.

What is claimed is:

1. A mirror housing clamp arrangement for a vehicle rearview mirror, with at least one mirror surface carried in a mirror head, wherein the mirror head is releasably fastened to a support structure; said clamp arrangement comprising:
said mirror head having at least one recess complimentary to the support structure into which the support structure is inserted;
a fastening device securing said mirror head to said support structure at said recess in said mirror head;
ratchet surfaces formed in said at least one recess and on a correlated complementary surface segment of said support structure; and,
wherein said fastening device is formed as an elastic component, which pre-stresses both ratchet surfaces in interlocking engagement.

2. The mirror arrangement according to claim 1, wherein said ratchet surface of the support structure is formed on a separate locking component, wherein said locking component at least partially corresponds to the surface contour of said support structure and the position of said locking component is fixed in its circumferential and axial direction relative to said support structure.

3. The mirror arrangement according to claim 2, wherein said support structure is a rod-shaped or tube-shaped component, and wherein said locking component surrounds the outer circumference of component in a ring-shaped manner.

4. The mirror arrangement according to claim 3, wherein said locking component is an open ring including a slot for being fitted and closed around the outer circumference of component.

5. The mirror arrangement according to claim 2 wherein at least one pin extending radially through said locking component locks the position of said locking component relative to said support structure, through engagement with said support structure.

6. The mirror arrangement according to claim 5, wherein said pin comprises an expanding mandrel.

7. The mirror arrangement according to claim 2, wherein said locking component is in positive-locking engagement with said recess in said mirror head in the axial direction of said support structure.

8. The mirror arrangement according to claim 2, wherein said elastic component is a clip, which presses on said locking component of said support structure adjacent said ratchet surfaces.

9. The mirror arrangement according to claim 8, wherein said clip has a generally U-shaped cross-section with two shanks interconnected by a flexible engaging surface, wherein said shanks are fastened to said mirror head so that said flexible engaging surface presses locking component of support structure with an elastic force.
